(19) United States
(12) Patent Application Publication
(10) Pub. No.: US 2006/0268581 A1
(43) Pub. Date: Nov. 30, 2006

(54) Method and apparatus for light guide unit and backlight module using the same

(75) Inventor: Ming-Fu Hsu, Tu-cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/353,590

(22) Filed: Feb. 14, 2006

(30) Foreign Application Priority Data
May 24, 2005 (CN) 200510034867.X

(51) Int. Cl. F21V 7/04

(52) U.S. Cl. 362/633; 362/629; 362/609

(57) ABSTRACT

A light guide unit includes a light guide plate and a frame. The light guide plate includes a light incident surface; a light emitting surface adjoining the light incident surface; a bottom surface opposite to the light emitting surface; and three side surfaces. The frame is integrated with the three side surfaces of the light guide plate. The light guide unit is integrally manufactured by two-shot injection molding. The light guide unit has a good utilization efficiency of light energy and an excellent luminescence for decreasing the occurrence of bright lines or dark lines at the boundary between the light guide plate and the frame. This light guide unit can be used in a backlight module.

### TECHNICAL FIELD

The present invention relates to a light guide unit and a method for making the same, and particularly, to a backlight module for use in, e.g., a liquid crystal display (LCD).

### GENERAL BACKGROUND

In a typical liquid crystal display, a backlight module is used to provide a planar light source for illuminating the liquid crystal display. In general, the backlight module includes a light source and a light guide plate, the light source being located adjacent to one side of the light guide plate. The light guide plate transforms light beams emitted from the light source into planar light beams, and directs the planar light beams to a liquid crystal panel of the liquid crystal display.

Referring to FIGS. 1 and 2, a conventional edge-lighting type backlight module 20 is shown. The backlight module 20 includes a light guide plate 10 having a light incident surface 102, a plurality of light sources 12 and a frame 14. The light sources 12 are disposed adjacent to the light incident surface 102. The light sources 12 may be cold cathode fluorescent lamps or light emitting diodes. The frame 14 is typically made of resin, and is for protecting and fixing the light guide plate 10.

The above-described backlight module 20 is usually assembled by hand. Typically, the assembly process is complex, time-consuming, and costly. Moreover, the elements of the backlight module 20 are normally not compactly attached together, there being gaps created therebetween. Light beams emitted from the light sources are partly leaked through the gaps, and are not emitted from the light guide plate, thereby utilization of the light beams is reduced.

In addition, because gaps are created between the light guide plate 10 and the frame 14, visible bright lines or dark lines occur at the gaps between the light guide plate and the frame, thereby the distribution of brightness of the backlight module may not be uniform.

What is needed, therefore, is a light guide unit and a method for manufacturing the same, and a backlight module using the same that overcomes the above mentioned disadvantages.

### SUMMARY

A light guide unit according to a preferred embodiment includes a light guide plate and a frame. The light guide plate includes a light incident surface; a light emitting surface adjoining the light incident surface; a bottom surface opposite to the light emitting surface; and three side surfaces. The frame is integrated with the three side surfaces of the light guide plate.

A method for manufacturing the same light guide unit as described in the previous paragraph is provided. The light guide unit is integrally manufactured by two-shot injection molding (also named two colored injection molding).

A backlight module according to another embodiment includes a light guide unit and at least a light source. The same light guide unit as described in the previous paragraph is employed in this embodiment.

Other advantages and novel features will become more apparent from the following detailed description of preferred embodiments when taken in conjunction with the accompanying drawings.

### BRIEF DESCRIPTION OF THE DRAWINGS

Many aspects of the light guide unit and the related backlight module having the same can be better understood with reference to the following drawings. The components in the drawings are not necessarily to scale, the emphasis instead being placed upon clearly illustrating the principles of the present light guide unit and the related backlight module. Moreover, in the drawings, like reference numerals designate corresponding parts throughout the several views.

FIG. 1 is a schematic, perspective view of a conventional backlight module;

FIG. 2 is a schematic, cross-sectional view taken along line II-II of FIG. 1;

FIG. 3 is a schematic, perspective view of a backlight module using a light guide unit, according to a first preferred embodiment;

FIG. 4 is an enlarged view of a circled portion IV of FIG. 3;

FIG. 5 is a schematic, cross-sectional view taken along line V-V of FIG. 3;

FIG. 6 is a schematic, cross-sectional view of a light guide unit, according to a second preferred embodiment;

FIG. 7 is a schematic, cross-sectional view of a light guide unit, according to a third preferred embodiment;

FIG. 8 is a schematic, cross-sectional view of a light guide unit, according to a fourth preferred embodiment;

FIG. 9 is a schematic, cross-sectional view of a light guide unit, according to a fifth preferred embodiment;

FIG. 10 is a schematic, cross-sectional view of a light guide unit, according to a sixth preferred embodiment;

FIG. 11 is a schematic, perspective view of a light guide unit, according to a seventh preferred embodiment; and

FIG. 12 is a schematic, cross-sectional view taken along line XII- XII of FIG. 11.

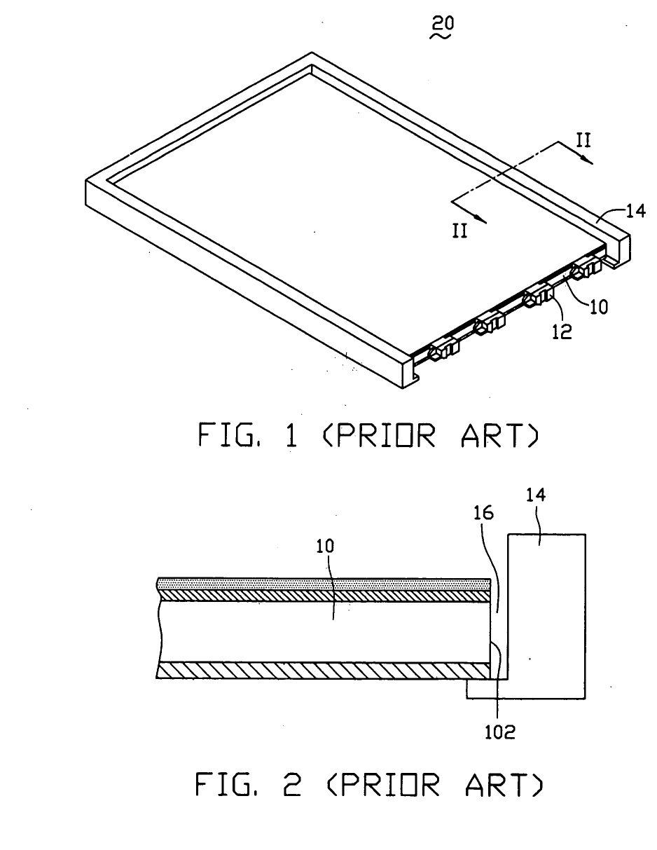

### DETAILED DESCRIPTION OF THE PREFERRED EMBODIMENTS

Reference will now be made to the drawings to describe preferred embodiments of the present method and apparatus for a light guide unit and the related backlight module, in detail.

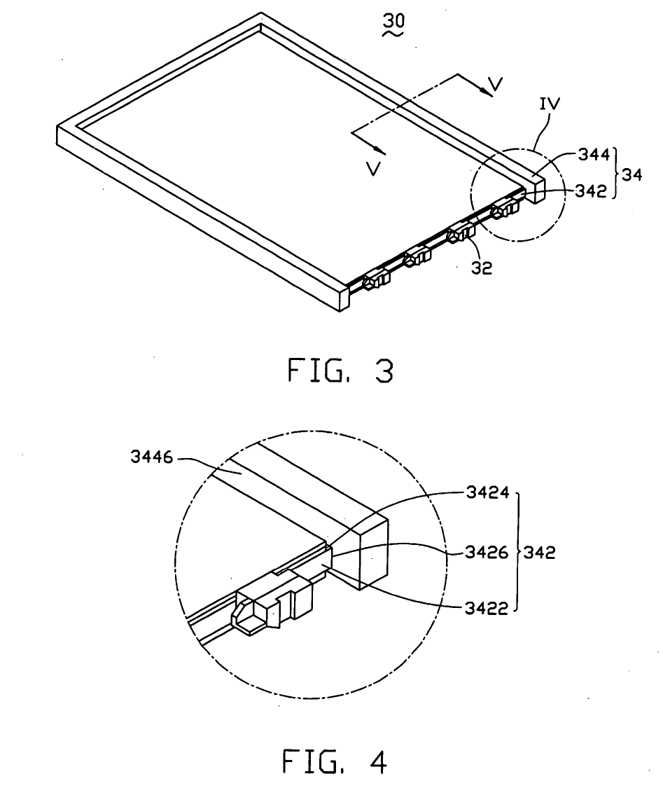

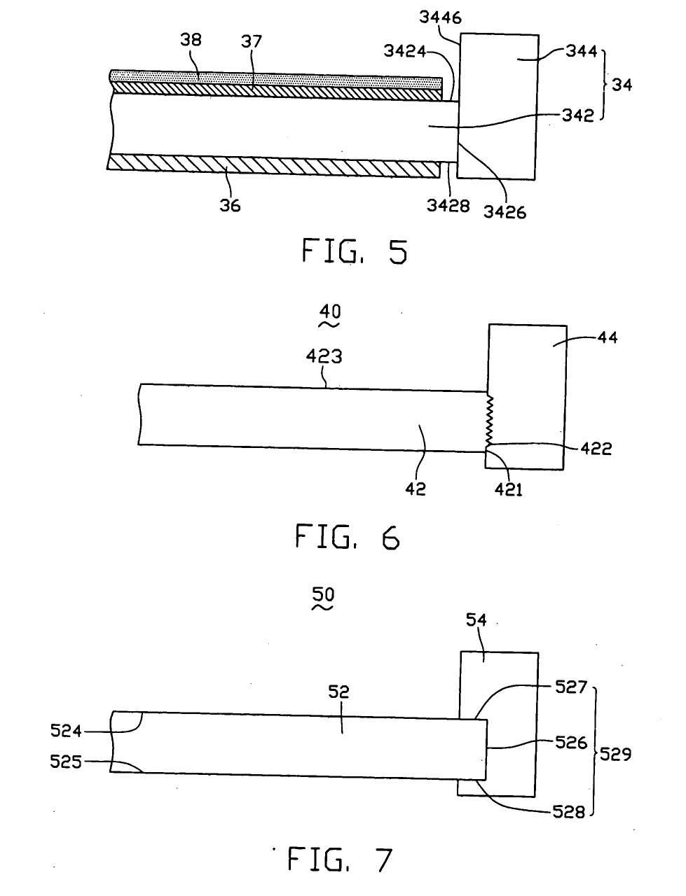

Referring to FIGS. 3, 4 and 5, a backlight module 30 of a display device, in accordance with a first embodiment, is shown. The backlight module 30 includes a light guide unit 34 and a plurality of light emitting diodes 32 (LEDs). The light guide unit 34 includes a plate-like light guide member 342 and a frame 344 at three sides of the light guide plate 342. The light guide plate 342 includes a light incident surface 3422; a light emitting surface 3424 adjoining the light incident surface 3422; a bottom surface 3428 opposite to the light emitting surface 3424; and three side surfaces 3426. The frame 344 includes three sidewalls 3446 which are connected with each other and are integrated with the three surfaces 3426 of the light guide plate 342, respectively.

The light guide unit 34 can be integrally manufactured by two-shot injection molding. In order to increase the bond strength between the light guide plate 342 and the frame 344, the light guide plate 342 and the frame 344 can be preferably formed of same resin material, provided the light guide plate 342 is sufficiently transparent and the frame 344 opaque. However, the light guide plate 342 and the frame 344 can also be formed with dissimilar resin materials.

A material of the light guide plate 342 can be selected, for example, from a group comprising of transparent polymethyl methacrylate (PMMA), polycarbonate (PC), modified PMMA, modified PC, and a combination thereof. A material of the frame 344 can be selected from a group comprising of colored PMMA, PC, modified PMMA, modified PC, and a combination thereof. The modified PMMA is manufactured by uniformly dispersing a plurality of modified particles into PMMA matrix material. In the same way, the modified PC is also manufactured by uniformly dispersing a plurality of modified particles into PC matrix material. The modified particles can be selected from a group comprising of silicon dioxide (SiO₂) particles and titanium dioxide (TiO₂) particles.

In the illustrated embodiment, a material of the light guide plate 342 is transparent PC and a material of the frame 344 is white PC which has a high reflective coefficient. Due to the light guide unit 34 being integrally manufactured by two-shot injection molding, the light guide plate 342 is combined with the frame 344 without gaps, thereby a substantial amount of the light beams emitted from the LEDs 32 are transmitted out from the light guide plate 342. In addition, a part of the light beams can be effectively reflected at the frame 344 and back into the light guide plate 342, thereby a utilization efficiency of light energy of the backlight module 30 is increased.

In order to improve the optical uniformity, the backlight module 30 preferably further includes a diffusing plate 37 and a brightness enhancement film 38 which are sequentially stacked one on another on the light emitting surface 3424 of the light guide plate 342.

In order to further improve utilization efficiency of light energy, the backlight module 30 preferably further includes a reflecting plate 36 disposed under the bottom surface 3428 of the light guide plate 342.

In order to for the light guide unit 34 to accommodate the reflecting plate 36, the diffusing plate 37, and the brightness enhancement film 38 together, dimensions of the frame 344 of the light guide unit 34 can be appropriately adjusted.

Because a distribution of light energy of the light beams reflected at sidewalls of the frame is not uniform, bright lines or dark lines still often occur at the boundary between the light guide plate and the frame of the light guide unit. In order to solve the above problem, a plurality of microstructures may be formed at the three side surfaces of the light guide plate to integrate with the frame, for uniformly scattering the reflecting light beams at the boundary as discussed in the following embodiments.

Referring to FIG. 6, a light guide unit 40 in accordance with a second preferred embodiment, is similar in principle to the light guide unit 34, except that a light guide plate 42 of the light guide unit 40 further includes a plurality of microstructures 422 formed at three side surfaces 421 of the light guide plate 42 corresponding to sidewalls of a frame 44. The microstructures 422 are integrated with the frame 44. The microstructures 422 are arranged along a direction perpendicular to a light emitting surface 423 of the light guide plate 42, for better and more uniform distribution of the light beams reflected at the sidewalls of the frame.

The microstructures 422 of the light guide unit 40 are configured for uniformly diffusing the reflecting light beams. The distribution density and sizes of the microstructures 422 enable the light guide unit 40 to control the reflecting light beams to emit uniformly, thereby avoiding the occurrence of bright lines or dark lines at the boundary between the light guide plate 42 and the frame 44. In addition, because of the microstructures 422, the interconnection of the light guide plate 42 and the frame 44 lends strength to the overall structure of the light guide unit 40. The microstructures 422 can be selected from a group comprising of V-shaped protrusions or grooves, semicircular protrusions or grooves, V-shaped protrusions or grooves having an obtuse vertex angle, and a combination thereof. In the illustrated embodiment, a shape of the microstructures 422 is a V-shaped protrusion. It is to be understood that the microstructures can also be arranged on a part of the three side surfaces of the light guide plate.

Referring to FIG. 7, a light guide unit 50 in accordance with a third preferred embodiment, is similar in principle to the light guide unit 34, except that three side surfaces 526 of a light guide plate 52 of the light guide unit 50 are inserted into a main body of a frame 54 of the light guide unit 50, and an insert portion 529 extended from the light guide plate 52 is formed, the insert portion 529 is integrated with sidewalls of the frame 54. The insert portion 529 of the light guide plate 52 is configured for further increasing the interconnection strength between the light guide plate 52 and the frame 54.

A shape of the insert portion 529 is a rectangular protrusion which includes a first surface 527 extending from a light emitting surface 524 of the light guide plate 52, a second surface 528 extending from a bottom surface 525 of the light guide plate 52, and a side surface 526 perpendicular to the first and second surfaces 527, 528.

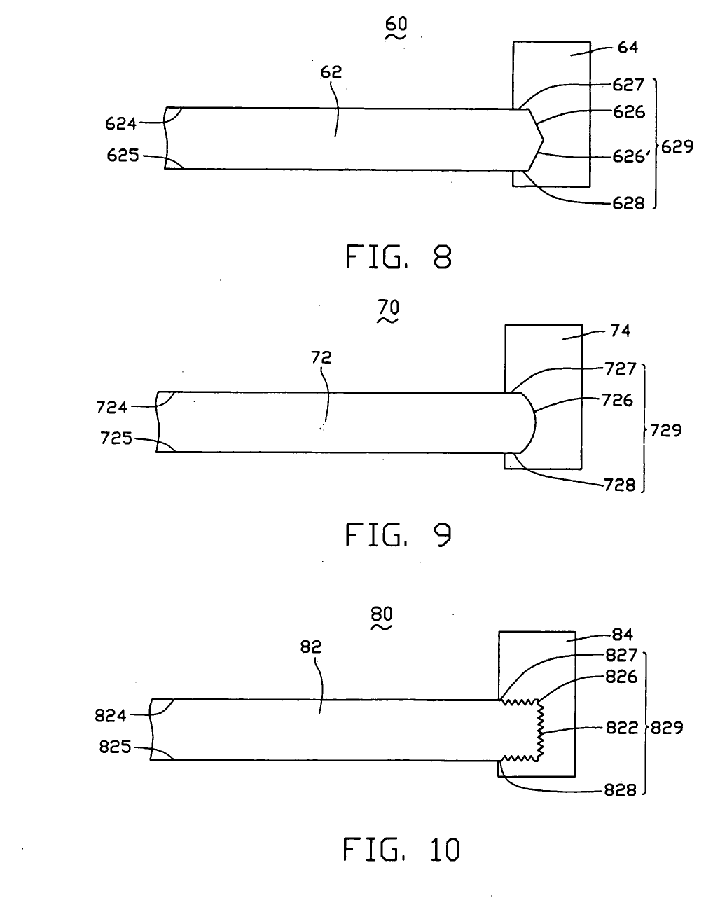

Referring to FIG. 8, a light guide unit 60 in accordance with a fourth preferred embodiment, is similar in principle to the light guide unit 50, except that an insert portion 629 of a light guide plate 62 is different from the insert portion 529. A shape of the insert portion 629 is a triangular protrusion extending from the light guide plate 62. The insert portion 629 includes a first surface 627 extending from a light emitting surface 624 of the light guide plate 62, a second surface 628 extending from a bottom surface 625 of the light guide plate 62, a first side surface 626 and a second side surface 626′ which intersects the first side surface 626.

Referring to FIG. 9, a light guide unit 70 in accordance with a fifth preferred embodiment, is similar in principle to the light guide unit 50, except that an insert portion 729 of a light guide plate 72 is different from the insert portion 529. A shape of the insert portion 729 is a curved protrusion extending from the light guide plate 72. The insert portion 729 includes a first surface 727 extending from a light emitting surface 724 of the light guide plate 72, a second surface 728 extending from a bottom surface 725 of the light guide plate 72, a curved surface 726 connected with the first surface 726 and the second surface 728.

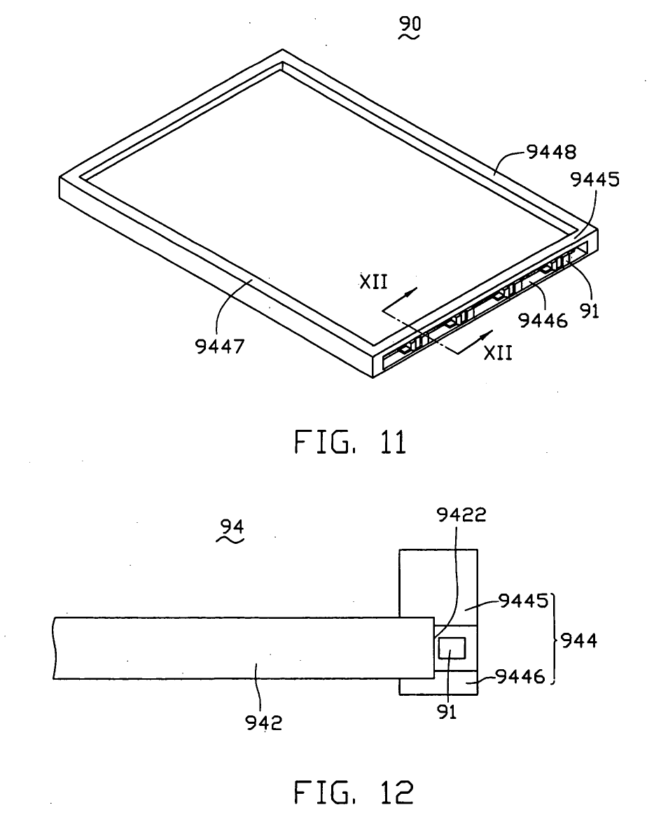

Referring to FIG. 10, a light guide unit 80 in accordance with a sixth preferred embodiment, is similar in principle to the light guide unit 50, except that a light guide plate 82 of the light guide unit 80 further includes a plurality of microstructures 822 formed at surfaces of an insert portion 829 of the light guide plate 82. The insert portion 829 includes a first surface 827 extending from a light emitting surface 824 of the light guide plate 82, a second surface 828 extending from a bottom surface 825 of the light guide plate 82, a side surface 826 connected with the first and second surfaces 827, 828 and perpendicular to the first and second surfaces 827, 828. The microstructures 822 are arranged on the side surface 826, and the first and second surfaces 827, 828, respectively. It is to be understood that the microstructures 822 can also be arranged on a part of the surfaces 826, 827, 828 of the insert portion 829 of the light guide plate 82. The same microstructures as described in paragraph 0034 are employed in this embodiment.

Referring to FIGS. 11 and 12, a backlight module 90 in accordance with a seventh preferred embodiment is shown. The backlight module 90 includes a plurality of LEDs 91 and a light guide unit 94 having a light guide plate 942 and a frame 944. The light guide plate 942 includes a light incident surface 9422 and the LEDs 91 are disposed adjacent to the light incident surface 9422. The backlight module 90 is similar in principle to the backlight module 30 of the first embodiment, except that the frame 944 further includes two incident sidewalls 9445, 9446 respectively interconnected with the ends of two adjacent opposite sidewalls 9447, 9448 thereof. The two incident sidewalls 9445, 9446 face each other and are respectively disposed adjacent to an upper side and a lower side of the light incident surface 9422 of the light guide plate 942. A light source holding chamber 95 is defined between the two incident sidewalls 9445, 9446 and the light incident surface 9422 for accommodating the LEDs 91.

Referring also to FIG. 12, in this illustrated embodiment, the light incident surface 9422 can be partly inserted into the two incident sidewalls 9445, 9446 of the frame 944 for further increasing the interconnection strength between the light guide plate 942 and the frame 944.

It is to be understood that the light sources of the present backlight module can also be cold cathode fluorescent lamps. It is noted that, various kinds of microstructures can also be formed on the light emitting surface and/or bottom surface of the light guide plate of present light guide unit, for improving optical uniformity of the present backlight module using the light guide unit.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A light guide unit, comprising:
a light guide plate including:
a light incident surface;
a light emitting surface adjoining the light incident surface;
a bottom surface opposite to the light emitting surface; and
three side surfaces; and
a frame being integrated with the three side surfaces of the light guide plate.

2. The light guide unit according to claim 1, wherein the light guide plate further includes a plurality of microstructures arranged on at least a part of the three side surfaces, and being integrated with the frame.

3. The light guide unit according to claim 2, wherein the shape of the microstructures can be selected from a group comprising of V-shaped protrusion or groove, semicircular protrusion or groove, V-shaped protrusion or groove having an obtuse vertex angle, and a combination thereof.

4. The light guide unit according to claim 1, wherein at least a part of the three side surfaces is inserted into a main body of the frame and an insert portion extended from the light guide plate is formed, the insert portion is integrated with sidewalls of the frame.

5. The light guide unit according to claim 4, wherein the shape of the insert portion can be selected from a group comprising of a rectangular protrusion, a triangular protrusion, and a curved protrusion.

6. The light guide unit according to claim 5, wherein the light guide plate further includes a plurality of microstructures periodically arranged on at least a part of the surfaces of the insert portion.

7. The light guide unit according to claim 6, wherein the shape of the microstructures can be selected from a group comprising of V-shaped protrusion or groove, semicircular protrusion or groove, V-shaped protrusion or groove having an obtuse vertex angle, and a combination thereof.

8. The light guide unit according to claim 1, wherein the frame includes three sidewalls that are respectively integrated with the three side surfaces of the light guide plate.

9. The light guide unit according to claim 8, wherein the frame further includes two incident sidewalls respectively interconnected with the ends of two adjacent opposite side surfaces thereof, and the two incident sidewalls face each other and are respectively disposed adjacent to an upper side and a lower side of the light incident surface.

10. The light guide unit according to claim 9, wherein the light incident surface of the light guide plate is partly inserted into the two incident sidewalls of the frame.

11. The light guide unit according to claim 1, wherein the light guide plate is comprised of a material selected from a group comprising of transparent polymethyl methacrylate, polycarbonate, modified polymethyl methacrylate, modified polycarbonate, and a combination thereof.

12. The light guide unit according to claim 11, wherein the modified polymethyl methacrylate is manufactured by uniformly dispersing a plurality of modified particles into the polymethyl methacrylate matrix material, and the modified polycarbonate is manufactured by uniformly dispersing a plurality of modified particles into the polycarbonate matrix material.

13. The light guide unit according to claim 12, wherein the modified particles is selected from a group comprising of silicon dioxide particles and titanium dioxide particles.

14. The light guide unit according to claim 1, wherein the frame is comprised of a material selected from a group comprising of colored polymethyl methacrylate, polycarbonate, modified polymethyl methacrylate, modified polycarbonate, and a combination thereof.

15. A backlight module comprising:
a light guide member defining a light incident surface for entry of light into said light guide member, a light emitting surface for exit of said light out of said light guide member;
a frame formed along at least one side of said light guide member other than said light incident surface and said light emitting surface for support of said light guide member in said backlight module so as to ensure no substantial gap formed between said frame and said at least one side of said light guide member; and
at least one light source disposed beside said light incident surface of said light guide member to provide said light to said light guide member.

16. The backlight module according to claim 15, wherein said frame is integrated with said light guide member along said at least one side thereof.

17. The backlight module according to claim 15, further including a reflecting plate disposed beside said light guide member opposite to said light emitting surface of said light guide member.

18. The backlight module according to claim 15, further including a diffusing plate disposed along said light emitting surface of said light guide member.

19. The backlight module according to claim 18, further including a brightness enhancement film disposed beside said diffusing plate opposite to said light guide member.

20. A display device comprising:
a light source of said display device;
a light guide member disposed in said display device next to said light source, said light guide member defining a light incident surface for entry of light from said light source into said light guide member, and a light emitting surface for exit of said light out of said light guide member; and
a frame formed along at least one side of said light guide member other than said light incident surface and said light emitting surface for positioning of said light guide member in said display device, said frame and said light guide member being relatively arranged so that said light in said light guide member travels toward said frame directly for reflection thereof by said frame without traveling through other light-traveling medium.
